(19) United States
(12) Patent Application Publication
(10) Pub. No.: US 2008/0239137 A1
(43) Pub. Date: Oct. 2, 2008

(54) IMAGING APPARATUS

(76) Inventor: Hideo YOSHIDA, Saitama-shi (JP)

Correspondence Address: BIRCH STEWART KOLASCH & BIRCH, PO BOX 747, FALLS CHURCH, VA, 22040-0747, US

(21) Appl. No.: 12/046,341

(22) Filed: Mar. 11, 2008

(30) Foreign Application Priority Data
Mar. 29, 2007 (JP) P2007-089634

(51) Int. Cl. H04N 5/225

(52) U.S. Cl. 348/340; 348/E05.024

(57) ABSTRACT

An imaging apparatus is provided and includes: an imaging optical system; an imaging device; a drive section that relatively moves the imaging optical system and the imaging device; and a control section that controls the drive section so as to repeatedly drive and stop the drive section during a period between successive times of confirming a relative moving amount of the imaging optical system and the imaging device.

### BACKGROUND OF THE INVENTION

1. Field of the Invention

The present invention relates to an imaging apparatus used for taking an image or the like.

2. Description of Related Art

As an imaging apparatus of a camera, a video camera, a camera mounted to a portable telephone or the like, there is known a camera for moving an imaging lens along an optical axis direction and moving the imaging lens by being driven by a piezoelectric element (for example, JP-A-11-356070). Further, there is also known a piezoelectric actuator for driving to expand and contract a piezoelectric element to move a member frictionally coupled therewith (for example, JP-A-6-194559 and JP-A-8-66064).

According to the apparatus of JP-A-11-356070, in order to maintain still sound performance in driving, when a piezoelectric element is driven at low speed, pulses of driving the piezoelectric element are continuously supplied without lowering a frequency a drive pulse thereof, thereafter, supply of the pulses is stopped to thereby intermittently supply the pulses.

However, according to such an apparatus, it is difficult to highly accurately move a moving member moved by driving an actuator of a piezoelectric element or the like. That is, when the drive pulses are intermittently supplied, the moving member is moved and stopped repeatedly. Therefore, a deviation of a moving amount of the moving member relative to a target moving amount is increased. Therefore, when the moving member is intended to move smoothly or the like, it is difficult to control to move the moving the moving member highly accurately. Further, when a state of driving per unit time is frequently carried out in order to reduce the deviation, high speed CPU is needed and CPU becomes expensive.

### SUMMARY OF THE INVENTION

An object of an illustrative, non-limiting embodiment of the invention is to provide an imaging apparatus capable of highly accurately controlling a relative movement of an imaging optical system and an imaging device.

According to an aspect of the invention, there is an imaging apparatus including: an imaging optical system; an imaging device; a drive section that relatively moves the imaging optical system and the imaging device; and a control section that controls the drive section so as to repeatedly drive and stop the drive section during a period between successive times of confirming a relative moving amount of the imaging optical system and the imaging device.

By controlling the drive section to repeatedly drive and stop the drive section during the period between successive times of confirming the relative moving amount of the imaging optical system and the imaging device, even when inexpensive CPU is used, the relative moving position of the imaging optical system and the imaging device can finely be controlled during the period from confirming to successively confirming the relative moving amount of the imaging optical system and the imaging device. Therefore, a relative positional relationship between the imaging optical system and the imaging device can be made to be proximate to a desired positional relationship and a highly accurate movement control can be carried out.

In the imaging apparatus, the control section may control the drive section so as to bring the drive section in a stopped state, a driving state and a stopped state during the period between successive times of confirming the relative moving amount of the imaging optical system and the imaging device.

In the imaging apparatus, the control section may controls the drive section by a combination of a first drive pattern of continuously driving the drive section during the period between successive times of confirming the relative moving amount of the imaging optical system and the imaging device; a second drive pattern of bringing the drive section in a stopped state, a driving state and a stopped state during the period between successive times of confirming the relative moving amount of the imaging optical system and the imaging device; and a third drive pattern of repeating stopping and driving the driving section multiple times during the period between successive times of confirming the relative moving amount of the imaging optical system and the imaging device.

In the imaging apparatus, the control section may correct a drive amount per unit time in accordance with a drive characteristic of the drive section. In this case, accuracy of controlling to move the imaging optical system and the imaging device can be corrected by correcting the drive amount per unit time in accordance with the drive characteristic of the drive section.

In the imaging apparatus, when a power is turned on, the control section may make the drive section operate to detect the drive characteristic of the drive section, and the control section may correct the drive amount per unit time in accordance with the detected drive characteristic.

By detecting the drive characteristic by driving the drive section when the power is turned on and correcting the drive amount per unit time in accordance with the detected drive characteristic, the drive section can be operated to drive by absorbing a variation in the drive characteristic in an environment of using the imaging apparatus of a temperature characteristic or the like of an electric part included in the imaging apparatus and further accurate relative movement control of the imaging optical system and the imaging device can be carried out.

In the imaging apparatus, the control section may control the drive section so that times of repeatedly driving or stopping the driving section during the period between successive times of confirming the relative moving amount of the imaging optical system and the imaging device are different.

The relative moving speed of the imaging optical system and the imaging device can be changed by controlling the drive section by making different times of driving or stopping the drive section repeated during the period. Therefore, when the drive section is used for driving a correction for unintentional hand movement, a case of changing a speed of the blurring sinusoidally can be dealt with and the pertinent unintentional hand movement correction can be carried out.

In the imaging apparatus, the control section may control the drive section so that the relative moving amount of the imaging optical system and the imaging device sinusoidally changes in time.

According to an aspect of the invention, there is provided an imaging apparatus including: an imaging optical system; an imaging device; a drive section that relatively moves the imaging optical system and the imaging device; and a control section that controls the drive section so as to input a drive pulse to the drive section so that the number of drive pulses per unit time becomes smaller as a time of operating the drive section in a same direction is longer.

In the relative movement of the imaging optical system and the imaging device, the longer the continuous drive in the same direction, the smaller the number of drive puleses per unit time inputted to the drive section. Therefore, the relative moving amount of the imaging optical system and the imaging device per unit time can be made to be proximate to be constant and the movement control can accurately be controlled.

According to an aspect of the invention, there is provided an imaging apparatus including: an imaging optical system; an imaging device; a drive section that relatively moves the imaging optical system and the imaging device; and a control section that controls the drive section input a drive pulse to the drive section so that the number of drive pulses per unit time in a case of reversing a moving direction in relatively moving of the imaging optical system and the imaging device in comparison with a case in which the moving direction is not reversed.

When the moving direction of the relative movement of the imaging optical system and the imaging device is reversed, the number of drive pulses per unit time inputted to the drive section is made to be larger than that in the case of not reversing the moving direction. Therefore, the drive section can be driven by applying the more drive pulses when started to move slowly by reversing the moving direction, and the moving amount per unit time can further be made to be proximate to be constant. Therefore, the movement control can accurately be carried out.

In the imaging apparatus, the control section may set an amount of increasing the number of drive pulses per unit time after reversion based on the number of drive pulses per unit time immediately before the reversing. Further, the control section may increase the amount of increasing the number of drive pulses per unit time after the reversing so that the number of drive pulses per unit time after the reversing is increased more as the number of drive pulses per unit time immediately before the reversing is larger.

In the imaging apparatus, the control section may set an amount of increasing the number of drive pulses per unit after reversion based on a relative moving amount of the imaging optical system and the imaging device per unit time immediately before the reversing. Further, the control section may increase the amount of increasing the number of drive pulses per unit time after the reversing so that the amount of increasing the number of drive pulses per unit time after the reversing is larger as the relative moving amount of the imaging optical system and the imaging device per unit time immediately before the reversing is larger.

In the imaging apparatus, the drive section may include an actuator, the actuator including a piezoelectric element and a drive shaft reciprocally moving in accordance with an operation of expanding or contracting the piezoelectric element, wherein the imaging optical system and the imaging device is relatively moved in accordance with moving a member frictionally engaged with the drive shaft.

### BRIEF DESCRIPTION OF THE DRAWINGS

The features of the invention will appear more fully upon consideration of the exemplary embodiment of the invention, which are schematically set forth in the drawings, in which:

FIG. 1 is a disassembled perspective view of an imaging portion and an unintentional hand movement correcting mechanism of an imaging apparatus according to an exemplary embodiment of the invention;

FIG. 2 is a plane view of the imaging portion and the unintentional hand movement correcting mechanism of the imaging apparatus of FIG. 1;

FIG. 3 is a sectional view taken along a line III-III of FIG. 2;

FIG. 4 is a sectional view taken along a line IV-IV of FIG. 2;

FIG. 5 is a block diagram showing an electric constitution of the imaging apparatus of FIG. 1;

FIG. 6 is an outline diagram of an unintentional hand movement correcting circuit of the imaging apparatus of FIG. 1;

FIG. 7 illustrates diagrams showing signal waveforms inputted to a first actuator and a second actuator of the imaging apparatus of FIG. 1;

FIG. 8 is an explanatory diagram of a drive control of the first actuator and the second actuator of the imaging apparatus of FIG. 1;

FIG. 9 is an explanatory view of a drive control of an imaging apparatus constituting a comparative example;

FIG. 10 is an explanatory diagram of a drive control of the first actuator and the second actuator of the imaging apparatus of FIG. 1;

FIG. 11 is an explanatory diagram of a drive control of an imaging apparatus constituting a comparative example;

FIG. 12 is an explanatory diagram of the drive control of the first actuator and the second actuator of the imaging apparatus of FIG. 1;

FIG. 13 is an explanatory diagram of the drive control of the first actuator and the second actuator of the imaging apparatus of FIG. 1;

FIG. 14 is an explanatory diagram of the drive control of the first actuator and the second actuator of the imaging apparatus of FIG. 1;

FIG. 15 is an explanatory diagram with regard to a correction of a drive amount of the imaging apparatus of FIG. 1;

FIG. 16 is an explanatory diagram of a drive characteristic of the first actuator and the second actuator of the imaging apparatus of FIG. 1;

FIG. 17 is a flowchart showing a drive pulse number correction processing of the imaging apparatus of FIG. 1;

FIG. 18 is a diagram showing a relationship between a drive amount and a drive pulse number of the imaging apparatus of FIG. 1;

FIG. 19 is a diagram showing a table of setting the drive amount and the drive pulse number of the imaging apparatus of FIG. 1;

FIG. 20 is a flowchart showing a drive pulse number correction processing of the imaging apparatus of FIG. 1;

FIG. 21 is a flowchart showing a pulse calculating processing of the imaging apparatus of FIG. 1;

FIG. 22 is a flowchart showing a pulse calculating processing of the imaging apparatus of FIG. 1;

FIG. 23 illustrates diagrams showing moving amounts after reversion when the pulse calculating processings of FIGS. 21 and 22 are carried out; and

FIG. 24 illustrates diagrams of a comparative example showing moving amounts after reversion when the pulse calculating processings of FIGS. 21 and 22 are carried out,

wherein some of reference numerals in the drawings are set forth below.

1: upper cover; 2: imaging optical system; 3: support shaft, 4: ball; 5: second moving member; 6: second actuator; 7: second support shaft; 8: first actuator; 9: position detecting magnet; 10: actuator; 11: first moving member; 12: first support shaft; 13: imaging device holder; 14: imaging device; 15: Hall element; 16: photointerrupter; 17: board; 20, 21 and 22: frictionally engaging portions; 30: first control portion; 40: second control portion; and 50: gyro sensor

### DETAILED DESCRIPTION OF THE EXEMPLARY EMBODIMENTS

Although the invention will be described below with reference to exemplary embodiments thereof, the following exemplary embodiments and modifications do not restrict the invention.

According to an exemplary embodiment of the invention, by repeating driving and stopping the drive section during the period between the successive times of confirming the relative moving amount of the imaging optical system and the imaging device, the relative movement of the imaging optical system and the imaging device can highly accurately be controlled. Therefore, inexpensive CPU can be adopted for the unintentional hand movement correcting system.

Exemplary embodiments of the invention will be explained in reference to the attached drawings as follows. Further, in explaining the drawings, the same elements are attached with the same notations and a duplicated explanation thereof will be omitted.

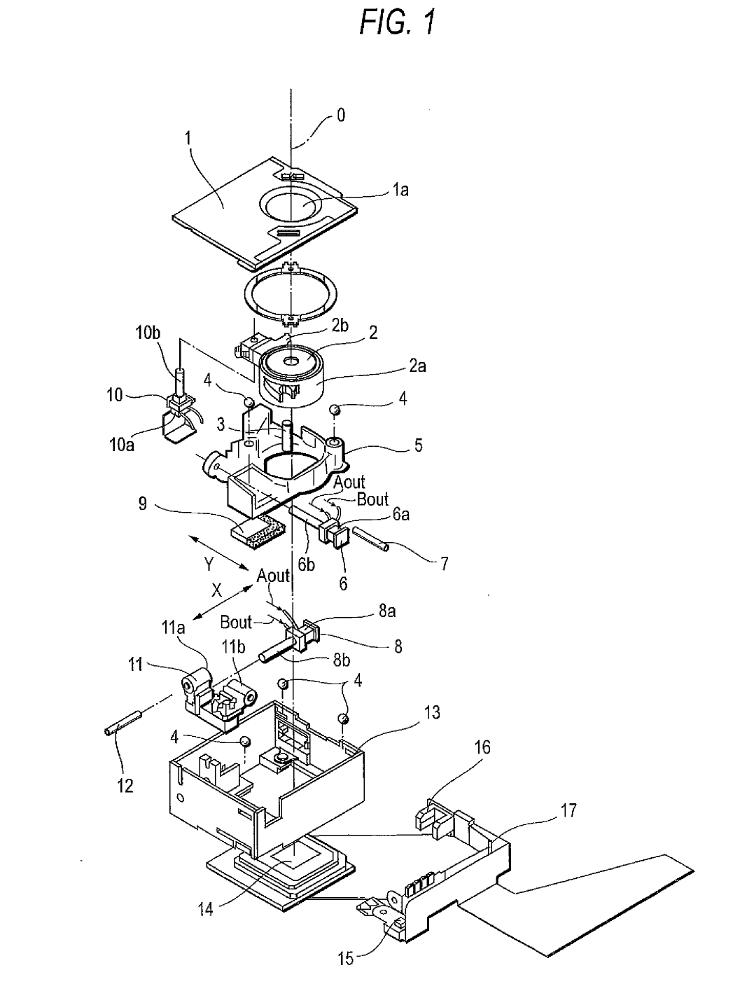

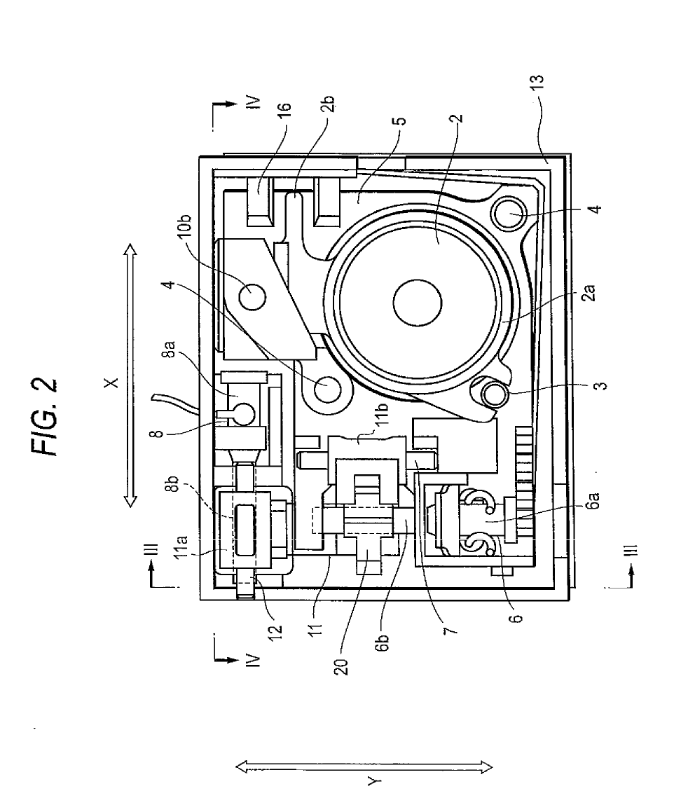

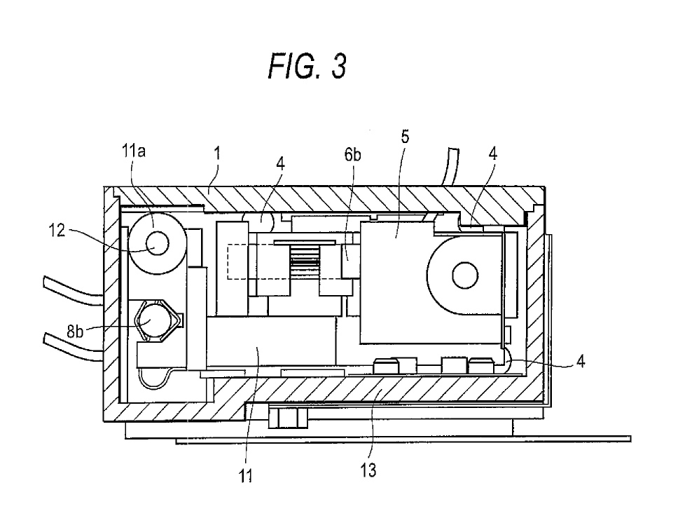

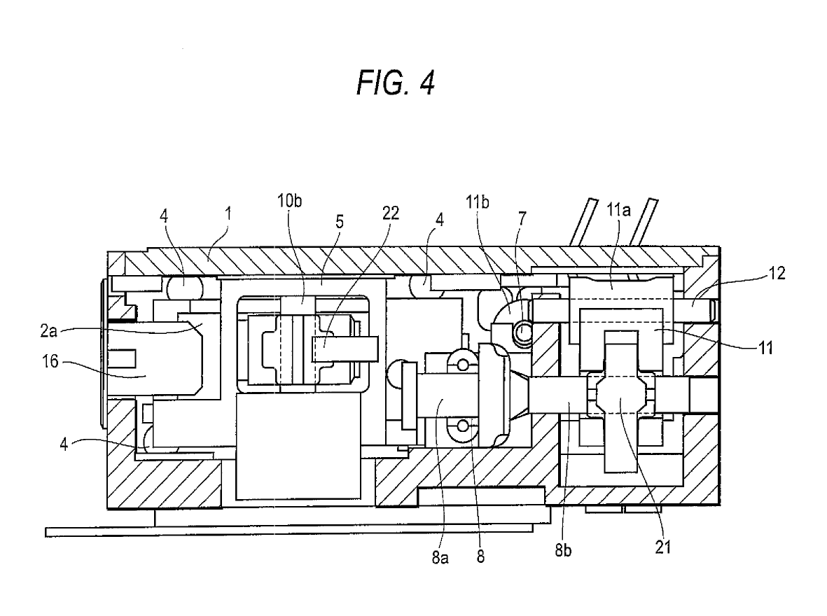

FIG. 1 is a disassembled perspective view of an imaging portion and an unintentional hand movement correcting mechanism of an imaging apparatus according to an exemplary embodiment of the invention. FIG. 2 is a plane view of the imaging portion and the unintentional hand movement correcting mechanism of the imaging apparatus according to the embodiment. FIG. 3 is a sectional view taken along a line III-III of FIG. 2. FIG. 4 is a sectional view taken along a line IV-IV of FIG. 2.

An imaging apparatus according to the embodiment corrects an unintentional movement of the hand by moving an imaging optical system and an imaging device relative to each other in a direction orthogonal to an optical axis direction. That is, the unintentional movement of the hand is corrected by moving the imaging optical system in accordance with the unintentional movement of the hand to thereby change a position thereof relative to the imaging device. The imaging apparatus is applied to a camera for taking an image of a still picture, a video camera for taking an image of a dynamic picture, an imaging portion mounted to a portable telephone or the like.

First, an explanation will be given of a mechanical constitution of an imaging apparatus according to the embodiment. As shown by FIG. 1, an imaging apparatus according to the embodiment includes an imaging optical system 2 and an imaging device 14 for acquiring an image of an object. The imaging optical system 2 is an optical system for converging light to the imaging device 14 and includes an imaging lens. The imaging optical system 2 includes a lens (not illustrated) incorporated in, for example, a holder 2a. The imaging optical system 2 may include a single member of a lens, or a lens group by a plurality of lenses.

An imaging device optical system 2 is attached to a second moving member 5 to be able to move relative to the imaging device 14 in a direction orthogonal to a direction of an optical axis O (optical axis direction). The second moving member 5 is contained in an image element holder 13 for fixing the imaging device 14 and is made to be able to move relative to the imaging device holder 13 and the imaging device 14 in the direction orthogonal to the optical axis direction by being supported by a spherical member 4. Therefore, the imaging optical system 2 is moved relative to the imaging device 14 in the direction orthogonal to the optical axis direction by moving the imaging optical system 2 along with the second moving member 5.

At this occasion, it is preferable to attach the imaging optical system 2 movably in the optical axis direction relative to the second moving member 5. For example, the second moving member 5 is attached with a support shaft 3 directed in the optical axis direction and the imaging optical system 2 is movably attached along the support shaft 3. There is used an actuator 10 for moving the imaging optical system 2 in the optical axis direction including a drive shaft 10b reciprocally moved by expanding and contracting a piezoelectric element 10a. The actuator 10 is made to function as a third actuator for moving the imaging optical system 2 in the optical axis direction. The piezoelectric element 10a is attached to the second moving member 5, and the drive shaft 10b is frictionally engaged with the imaging optical system 2 by a frictionally engaging portion 22 (refer to FIG. 4). One end of the drive shaft 10b is brought into contact with the piezoelectric element 10a and is adhered thereto by using, for example, an adhering agent. The drive shaft 10b is a member of an elongated shape and the drive shaft 10b in, for example, a shape of a circular pillar is used.

A frictionally engaging structure includes a structure in which the drive shaft 10b is brought into a state of being brought into press contact with the holder 2a of the imaging optical system 2 by a constant press force by a leaf spring to produce a constant frictional force when the drive shaft 10b is moved. By moving the drive shaft 10b to exceed the frictional force, a position of the imaging optical system 2 is maintained by an inertia. On the other hand, when the drive shaft 10b is moved in a reverse direction so as not to exceed the frictional force, also the imaging optical system 2 is moved in the reverse direction. By reciprocally moving the drive shaft 10b repeatedly in this way, the image optical system 2 can be moved relative to the second moving member 5. The piezoelectric element 10a is inputted with an electric signal making an expansion speed and a contraction speed thereof differ from each other from a control portion (not illustrated). Thereby, the drive shaft 10b is reciprocally moved by the different speeds to be able to control to move the imaging optical system 2.

By attaching the image optical system 2 to the second moving member 5 movably in the optical axis direction in this way, focusing can be carried out by moving only the imaging optical system 2 relative to the second moving member 5 in the optical axis direction. Therefore, it is not necessary to carry out focusing by moving a total of the unintentional hand movement correcting mechanism. Therefore, a part moved by focusing becomes small, and therefore, the unintentional hand movement correcting mechanism can be constituted to be small.

The imaging device 14 is imaging means for converting an image focused by the imaging optical system 2 into an electric signal and is fixed to be attached to the imaging device holder 13. As the imaging device 14, for example, a CCD sensor is used.

The imaging apparatus according to the embodiment includes a first actuator 8, a second actuator 6, and a first moving member 11. The first actuator 8 is an actuator for relatively moving the imaging optical system 2 and the imaging device 14 in a first direction (yaw direction) X orthogonal to the optical axis direction. There is used the first actuator 8 including a drive shaft 8b reciprocally moved by expanding and contracting a piezoelectric element 8a. The drive shaft 8b is arranged in the first direction X. The piezoelectric element 8a is attached to the imaging device holder 13 fixed with the imaging device 14. The drive shaft 8b is frictionally engaged with the first moving member 11 by a frictionally engaging portion 21 (refer to FIG. 4). One end of the drive shaft 8b is brought into contact with the piezoelectric element 8a and is adhered thereto by using, for example, an adhering agent. The drive shaft 8b is a member in an elongated shape and the drive shaft 8b in, for example, a shape of a circular pillar is used.

A frictionally engaging structure includes a structure in which the drive shaft 8b is brought into a state of being brought into press contact with the first moving member 11 by a constant press force by, for example, a leaf spring and a constant friction force is produced when the drive shaft 8b is moved. A position of the first moving member 11 is maintained by an inertia by moving the drive shaft 8b to exceed the frictional force. On the other hand, when the drive shaft 8b is moved in a reverse direction so as not to exceed the frictional force, also the first moving member 11 is moved in the reverse direction. By reciprocally moving the drive shaft 8b repeatedly in this way, the first moving member 11 can be moved along the first direction X relative to the imaging device 14, and the image optical system 2 can be moved in the first direction X relative to the imaging device 14. The piezoelectric element 8a is inputted with an electric signal making an expansion speed and a contraction speed thereof differ from each other from a control portion (not illustrated). Thereby, the imaging optical system 2 can be controlled to move by reciprocally moving the drive shafts 8b by the different speeds.

Further, there is also a case in which the first actuator 8 is constituted by attaching the piezoelectric element 8a to a side of the first moving member 11 and frictionally engaging the drive shaft 8b with the imaging device holder 13.

The second actuator 6 is an actuator for moving the imaging optical system 2 and the imaging device 14 relative to each other in a second direction (pitch direction Y orthogonal to the optical axis direction. The second actuator 6 and the first actuator 8 function as drive section for moving the imaging optical system 2 and the imaging device 14 relative to each other.

The second direction Y is a direction orthogonal to the optical axis direction and intersecting with the first direction X and is set to a direction orthogonal to, for example, the first direction X. There is used the second actuator 6 including a drive shaft 6b for reciprocally moving by expanding and contracting a piezoelectric element 6a. The drive shaft 6b is arranged to be directed in the second direction Y. The piezoelectric element 6a is attached to the second moving member 5. The drive shaft 6b is frictionally engaged with the first moving member 11 by a frictional engaging portion 20 (refer to FIG. 2). One end of the drive shaft 6b is brought into contact with the piezoelectric element 6a and is adhered thereto by using, for example, an adhering agent. The drive shaft 6b is an elongated member and the drive shaft 6b in, for example, a shape of a circular column is used.

A frictionally engaging structure includes a structure in which the drive shaft 6b is brought into a state of being brought into press contact with the first moving member 11 by a constant press force by, for example, a leaf spring and a constant frictional force is produced when the drive shaft 6b is moved. A position of the second moving member 5 is maintained by an inertia by moving the drive shaft 6b in one direction to exceed the frictional force. On the other hand, when the drive shaft 6b is intended to move in a reverse direction so as not to exceed the frictional force, the second moving member 5 is moved in one direction while the drive shaft 6b stays to be stationary by the frictional force. By repeating the reciprocal movement of the drive shaft 6b in this way, the second moving member 5 can be moved along the second direction Y relative to the imaging device 14, and the imaging optical system 2 can be moved in the second direction Y relative to the imaging device 14. The piezoelectric element 6a is inputted with an electric signal for making an expansion speed and a contraction speed thereof differ from each other from a control portion (not illustrated). Thereby, the drive shaft 6b is reciprocally moved by the different speeds to be able to control to move the imaging optical system 2.

The first moving member 11 is attached with the second actuator 6 by the above-described frictional engagement. Therefore, by moving the first moving member 11 in the first direction X by operating the first actuator 8, also the second actuator 6 is moved in the first direction X.

Further, there is also a case in which the second actuator 6 is constituted by attaching the piezoelectric element 6a to a side of the first moving member 11 and frictionally engaging the drive shaft 6b with the second moving member 5.

The imaging apparatus is provided with a position detecting magnet 9 and a Hall element 15. The position detecting magnet 9 is a magnet attached to the second moving member 5, which serves well so far as a magnetic field capable of being detected by the Hall element 15 is generated thereby. The Hall element 15 is a magnetic sensor for detecting relative positions of the imaging device 14 and the imaging optical system 2 in a direction orthogonal to the optical axis direction based on a state of a magnetic field generated from the position detecting magnet 9, and is attached to, for example, a board 17. The Hall element 15 capable of detecting relative positions in two directions orthogonal to the optical axis direction is used, for example, the Hall element 15 having two elements is used. The board 17 is a wiring board attached to the imaging device holder 13 and is used by being folded to bend in, for example, an L-like shape. According to the board 17, lead wires of the piezoelectric elements 6a, 8a and 10a are respectively attached to the board 17.

The imaging apparatus is provided with a photointerrupter 16. The photointerrupter 16 is a position detecting sensor for detecting a position of the imaging optical system 2. The photointerrupter 16 is attached to the board 17 and is arranged at a position proximate to the imaging optical system 2. The photointerrupter 16 includes a light emitting portion and a light receiving portion and detects a position in the optical axis direction of the imaging optical system 2 by detecting a position of a moving piece 2b passing between the light emitting portion and the light receiving portion. The moving piece 2b is a member formed at the holder 2a of the imaging optical system 2 and moved integrally with the imaging optical system 2.

The imaging apparatus includes an upper cover 1. The upper cover 1 is a cover for covering an opening portion of the imaging holder 13 containing the imaging portion and the hand unintentional movement correcting mechanism and is formed with an opening portion 1a for making an object image incident thereon.

As shown by FIG. 2, the first moving member 11 is supported movably along the first direction X by a first support shaft 12. The first support shaft 12 is a shaft member arranged to be directed in the first direction X and is attached to the imaging holder 13. The first support shaft 12 is provided to penetrate a bearing portion 11a of the first moving member 11. Thereby, the first moving member 11 is supported to move only in the first direction X relative to the imaging device 14 by the first support shaft 12.

The first support shaft 12 is arranged on a side of the first actuator 8 relative to the imaging optical system 2. That is, the first support shaft 12 is not arranged on a side opposed to the first actuator 8 by interposing the imaging optical system 2 but is arranged on the side of the first actuator 8. Therefore, a moving mechanism by the first actuator 8 and a support mechanism by the first support shaft 12 can be constituted to summarize compactly.

The second moving member 5 is supported by a second support shaft 7 movably along the second direction Y. The second support shaft 7 is a shaft member arranged to be directed in the second direction Y and is attached to the second moving member 5. The second support shaft 7 is provided to penetrate a bearing portion 11b of the first moving member 11. Thereby, the second moving member 5 is supported to move only in the second direction Y relative to the first moving member 11 by the second support shaft 7.

The second support shaft 7 is arranged on a side of the second actuator 6 relative to the imaging optical system 2. That is, the second support shaft 7 is not arranged on a side opposed to the second actuator 6 by interposing the imaging optical system 2 but is arranged on the side of the second actuator 6. Therefore, a moving mechanism by the second actuator 6 and a support mechanism by the second support shaft 7 can be constituted to summarize compactly.

It is preferable to arrange the first actuator 8 and the second actuator 6 in a T-like shape. For example, a front end portion of the second actuator 6 is directed to a middle portion of the first actuator 8 to be integrated in the T-like shape.

Thereby, the drive shafts 8b and 6b of the first actuator 8 and the second actuator 6 can be arranged to be proximate to each other. Therefore, the first moving member 11 engaged with both of the drive shaft 8b and the drive shaft 6b can be constituted to be small. Therefore, small-sized formation of the imaging apparatus can be achieved.

Further, the T-like shape mentioned here includes not only a case of integrating the first actuator 8 and the second actuator 6 completely in the T-like shape but also a case in which the actuators are integrated substantially in the T-like shape. For example, in a case in which a front end portion of other of the first actuator 8 and the second actuator 6 is directed to a middle portion of one thereof, there may be constituted a case in which there is a predetermined space between the middle portion and a front end portion, or a case in which the front end portion is directed to a position deviated from a center of the middle portion. Also in these cases, the first moving member 11 engaged with both of the drive shaft 8b and the drive shaft 6b can be constituted to be small and small-sized formation of the imaging apparatus can be achieved.

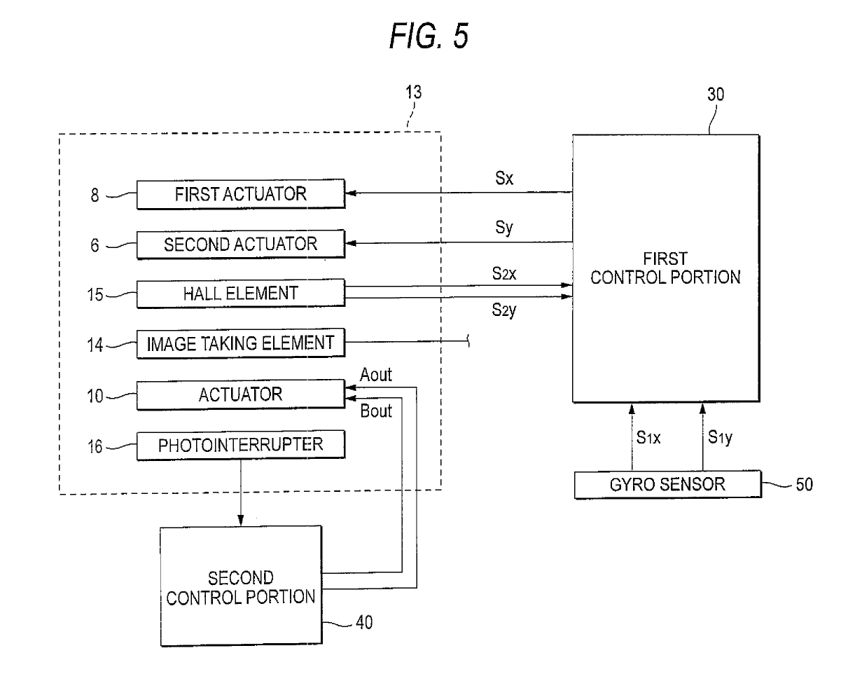

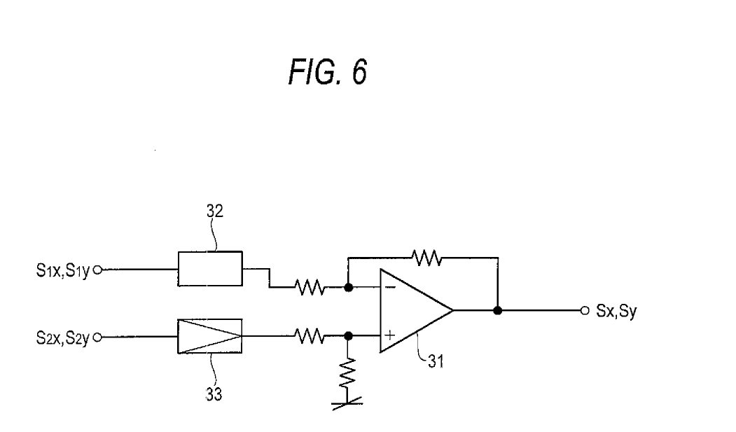

FIG. 5 is a block diagram showing an electric constitution of the imaging apparatus according to the embodiment. FIG. 6 is an outline diagram of an unintentional hand movement correcting circuit of the imaging apparatus according to the embodiment.

As shown by FIG. 5, the imaging apparatus according to the embodiment includes a first control portion 30, a gyro sensor 50 and a second control portion 40. The first control portion 30 functions as control section for correcting the unintentional hand movement by controlling the relative movement of the imaging optical system 2 and the imaging device 14 in the direction orthogonal to the optical axis direction. The first control portion 30 includes LSI (Large Scale Integration) or the like including, for example, CPU, and a driver chip. The gyro sensor 50 is arranged outside of a vibration isolating unit, that is, outside of the imaging device holder 13.

The first control portion 30 inputs a detecting signal S1x of the gyro sensor 50 and a detecting signal S2x of the Hall element 15 and outputs a drive control signal Sx to the first actuator 8. The detecting signal S1x of the gyro sensor 50 is a detecting signal with regard to an unintentional hand moving amount in the first direction X (X direction). The detecting signal S2x of the Hall element 15 is a detecting signal with regard to the relative positions of the imaging device 14 and the imaging optical system 2 in the first direction X.

Further, the first control portion 30 inputs a detecting signal S1y of the gyro sensor 50 and a detecting signal S2y of the Hall element 15 and outputs a drive control signal Sy to the second actuator 6. The detecting signal S1y of the gyro sensor 50 is a detecting signal with regard to an unintentional hand moving amount in the second direction Y (Y direction). The detecting signal S2y of the Hall element 15 is a detecting signal with regard to the relative positions of the imaging device 14 and the imaging optical system 2 in the second direction Y.

For example, as shown by FIG. 6, inside of the first control portion 30 is provided with an unintentional hand movement correcting circuit using a differential amplifier 31. There are provided two of the unintentional hand movement correcting circuits for carrying out an unintentional hand movement correction in X direction and carrying out an unintentional hand movement correction in Y direction. The unintentional hand movement correcting circuit in X direction outputs the drive control signal Sx to the first actuator in accordance with a difference between the detecting signal S1x of the gyro sensor 50 and the detecting signal S2x of the Hall element 15. The unintentional hand movement correcting circuit in Y direction outputs the drive control signal Sy of the second actuator 6 in accordance with a difference between the detecting signal S1y of the gyro sensor 50 and the detecting signal S2y of the Hall element 15. Thereby, the unintentional hand movement correction is carried out by reducing the difference between the unintentional hand moving amount and the relative moving amounts of the imaging optical system 2 and the imaging device 14.

It is preferable to process to integrate the detecting signals S1x and S1y by an integrating circuit 32 to be inputted to the differential amplifier 31. Further, it is preferable to amplify to process the detecting signals S2x and S2y of the Hall element 15 by an amplifying circuit 33 to be inputted the differential amplifier 31.

In FIG. 5, the second control portion 40 functions as control section for controlling a movement of the imaging optical system 2 in the optical axis direction. The second control portion 40 includes, for example, an IC for autofocusing or a microcomputer or the like. The second control portion 40 acquires distance information to an object by a distance measuring apparatus, not illustrated, outputs the drive control signal to the actuator 10 based on the distance information and a detecting signal of the photointerrupter 16 to control to move the imaging optical system 2.

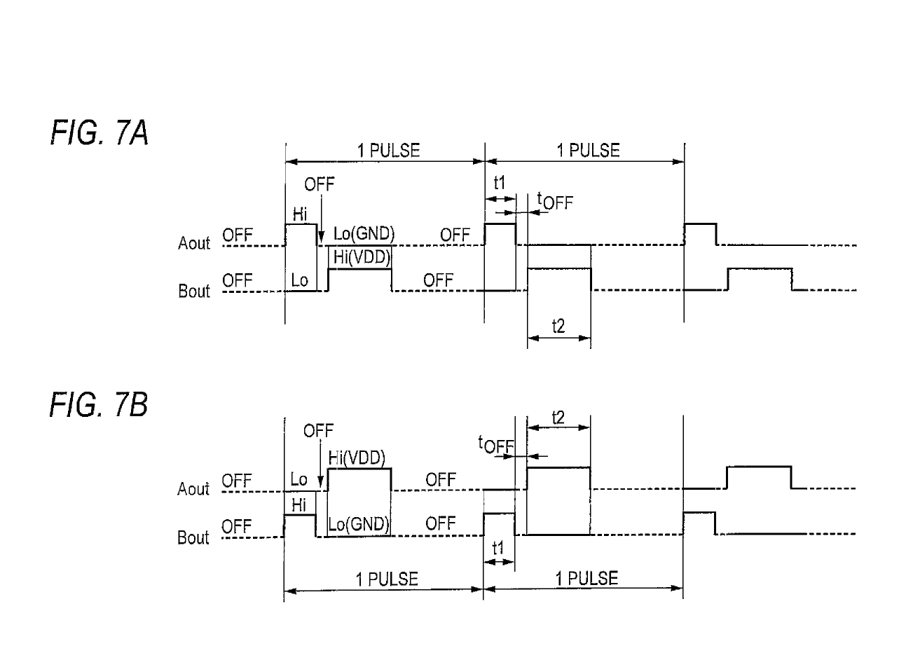

FIG. 7 shows an example of signal waveforms inputted to the first actuator 8 and the second actuator 6.

FIG. 7(A) shows a signal when the frictionally engaged member is moved in a direction of being proximate to the piezoelectric elements 6a and 8a (signal in regular rotation) and FIG. 7(B) shows a signal inputted when the frictionally engaged member is moved in a direction of being remote from the piezoelectric elements 6a and 8a (signal in reverse rotation), In FIGS. 7(A) and (B), respective twos of pulse signals Aout and Bout are signals inputted to two terminals of the piezoelectric elements 6a and 8a and are signals constituting the drive control signals Sx and Sy mentioned above. The larger the voltage differences of the pulse signals, the larger the amounts of expanding for expanding the piezoelectric elements 6a and 8a, and the piezoelectric elements 6a and 8a are expanded and contracted by varying the voltage differences.

The signals of the FIGS. 7(A) and 7(B) are signals in driving the first actuator 8 and the second actuator 6. Continuous driving is carried out by inputting respective pulses of the signals continuously to the first actuator 8 and the second actuator 6.

On the other hand, signals when the first actuator 8 and the second actuator 6 are not driven are signals nullifying voltage differences inputted to the two terminals of the piezoelectric elements 6a and 8a although not illustrated. Further, it is preferable that input signals when the actuators are not driven nullifying the voltage differences are constituted by signals nullifying the voltage differences by long periods equal to or longer than a period of 1 pulse of the input signals in driving shown in FIGS. 7(A) and (B).

Further, the signals inputted to the first actuator 8 and the second actuator 6 are not limited to those shown in FIG. 7, and may not be pulse signals but may be signals of a tooth wave shape or signals of a triangular wave shape or the like.

Next, an explanation will be given of operation in correcting the unintentional hand movement in the imaging apparatus according to the embodiment.

In FIG. 5, when there is brought about the unintentional hand movement in taking an image by using the imaging apparatus, the gyro sensor 50 detects the unintentional hand movement amount and outputs the detecting signal S1 of the unintentional hand movement to the first control portion 30. The first control portion 30 outputs the drive control signals to the first actuator 8 and the second actuator 6 such that an image taken by the imaging device 14 is not unintentionally moved by the hand based on the detecting signal S1 of the gyro sensor 50 and the detecting signal S2 of the Hall element 15.

When the imaging optical system 2 and the imaging device 14 are moved relative to each other by driving the first actuator 8 or the second actuator 6, the imaging optical system 2 and the imaging device 14 are controlled to be driven to repeat to drive and not to drive and the first actuator 8 or the second actuator 6 during a period between time of confirming and successively confirming the relative moving amounts of the imaging optical system 2 and the imaging device 14.

For example, during a period from time of confirming to time of successively confirming the relative moving amounts of the imaging optical system 2 and the imaging device 14 by reading the detecting signal S2 of the Hall element 15, the first actuator 8 and the second actuator 6 are controlled to be driven to repeat drive states and non-drive states thereof. Thereby, the piezoelectric elements 8a and 6a of the first actuator 8 and the second actuator 6 are continuously operated to be expanded and contracted in the drive state and stopped to be operated to be expanded and contracted in the non-drive state.

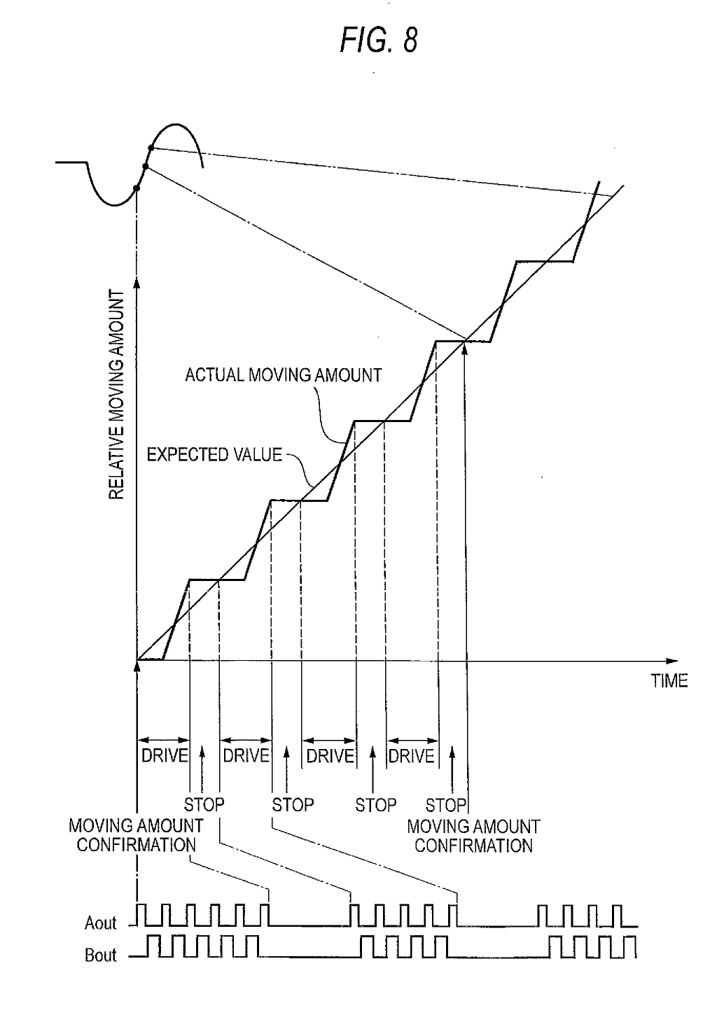

When the imaging optical system 2 and the imaging device 14 are controlled to be driven in this way, as shown by FIG. 8, according to the relative moving amounts of the imaging optical system 2 and the imaging device 14, the moving amounts are increased in the drive state of the first actuator 8 and the second actuator 6, and the moving amounts are not varied in the non-drive state. Therefore, the relative moving amount of the imaging optical system 2 and the imaging device 14 is increased in steps and becomes a moving amount proximate to an expected value (an ideal moving amount for restraining unintentional hand movement correction). Therefore, the unintentional hand movement correction can pertinently be carried out.

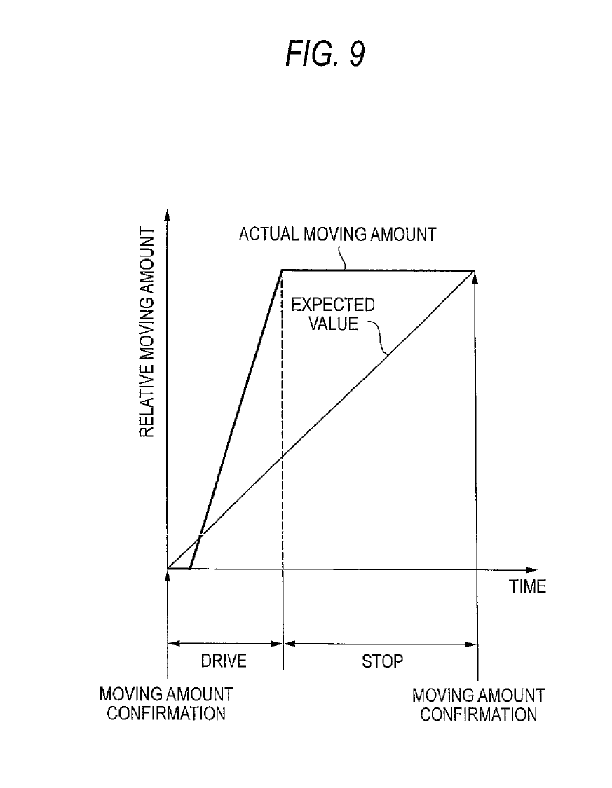

In contrast thereto, as shown by FIG. 9, although the first actuator 8 or the second actuator 6 is driven and not driven during a period between successive times of confusing the relative moving amount of the imaging optical system 2 and the imaging device 14, when the repetition thereof is not carried out, an actual relative moving amount is considerably deviated from an unexpected value. For example, when the drive state is constituted by a period after confirming the movement and the non-drive state is constituted by a period thereafter, the relative movement becomes large in the drive state to be considerably deviated from the expected value. In the imaging apparatus according to the embodiment, by repeating the drive state and the non-drive state as shown by FIG. 8, the moving amount is gradually increased, and therefore, the relative movement of the imaging optical system 2 and the imaging device 14 can be carried out in the form in line with the expected value.

Further, when the expected value is constituted by a curve, it is preferable to control to drive the first actuator 8 or the second actuator 6 by making a period of driving or a period of non-driving the first actuator 8 or the second actuator 6 repeated during a period between successive times of confirming the relative movement amount of the imaging optical system 2 and the imaging device 14 differ. For example, in changing the unintentional hand moving amount, the amount is frequently changed sinusoidally. In such a case, it is preferable to control to drive the first actuator 8 or the second actuator 6 such that the change over time of the relative moving amount of the imaging optical system 2 and the imaging device 14 to be sinusoidal.

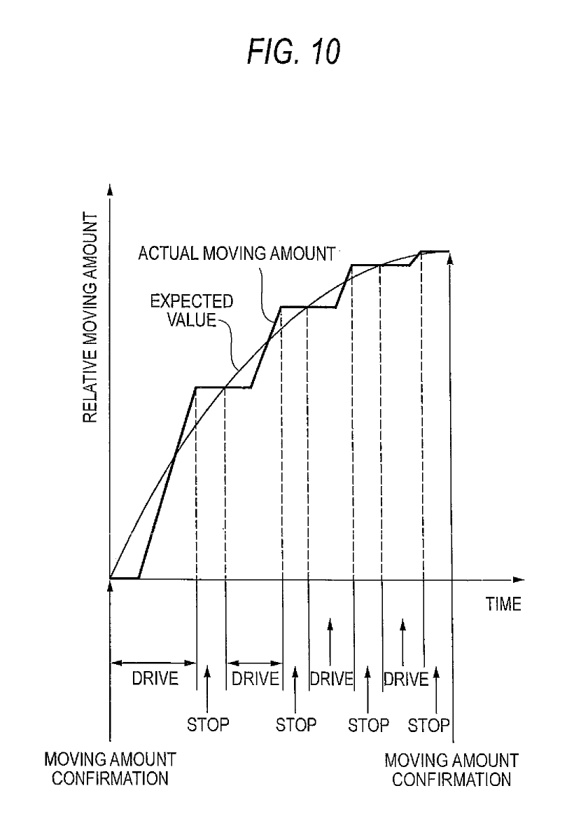

For example, as shown by FIG. 10, the relative moving amount of the imaging optical system 2 and the imaging device 14 can be changed in a curve shape by making a period of driving the first actuator 8 or the second actuator 6 repeated during a period between successive times of confirming the relative moving amount of the imaging optical system 2 and the imaging device 14 differ. Therefore, the relative moving amount of the imaging optical system 2 and the imaging device 14 can be changed in the form in line with the expected value, and the pertinent unintentional hand movement collection can be carried out. Particularly, the change in the vibration of the unintentional hand movement is frequently constituted by a sinusoidal shape, and therefore by sinusoidally changing the relative movement of the imaging optical system 2 and the imaging device 14, the pertinent unintentional hand movement correction can be carried out. Further, the sinusoidal shape mentioned here includes not only a complete sinusoidal shape but also substantially a sinusoidal shape.

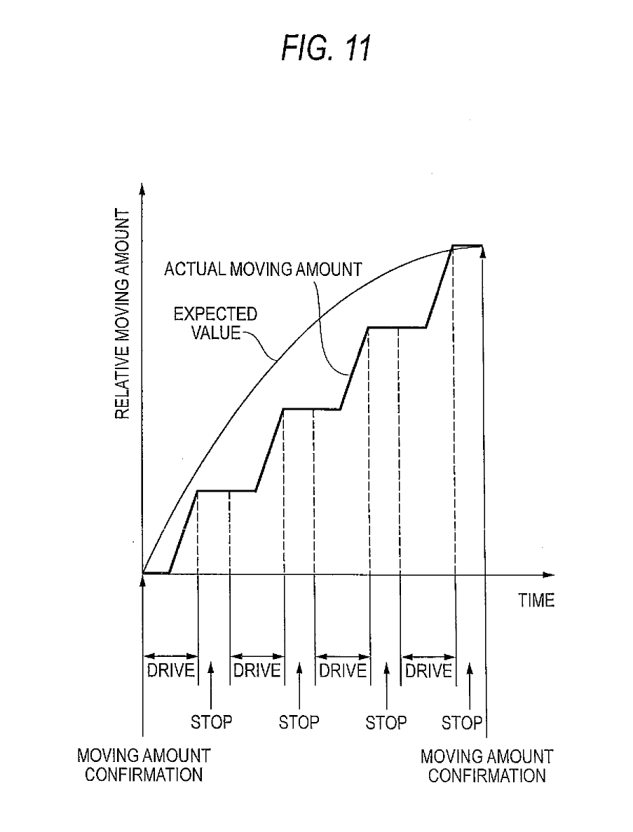

In contrast thereto, as shown by FIG. 11, when the period of driving the first actuator 8 or the second actuator 6 repeated during the period between successive times of confirming the relative moving amount of the imaging optical system 2 and the imaging device 14 is made to stay the same, the actual relative moving amount is considerably deviated from the expected value. In the imaging apparatus according to the embodiment, by making the period in the drive state or the period in the non-drive state differ in accordance with the change in the unintentional hand movement amount (expected value) as shown by FIG. 10, the relative movement of the imaging optical system 2 and the imaging device 14 can be carried out in the form in line with the expected value.

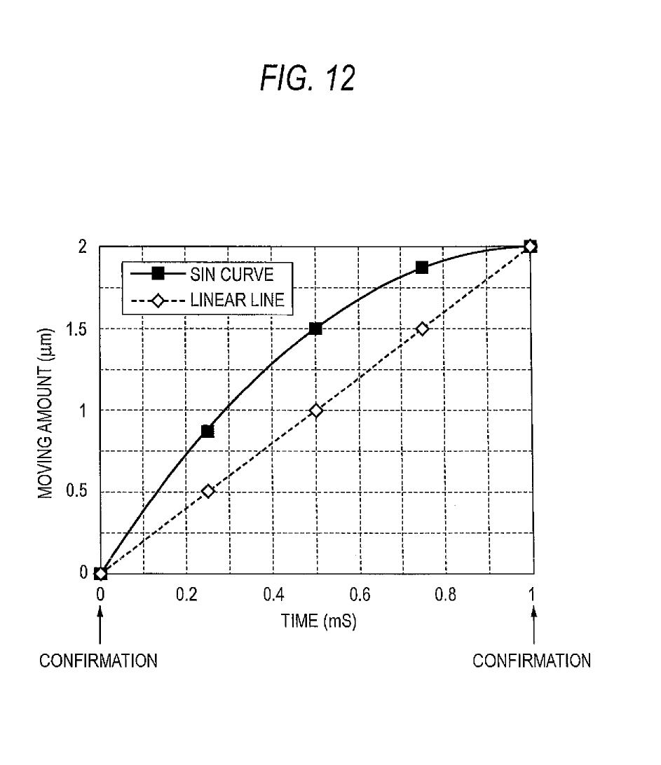

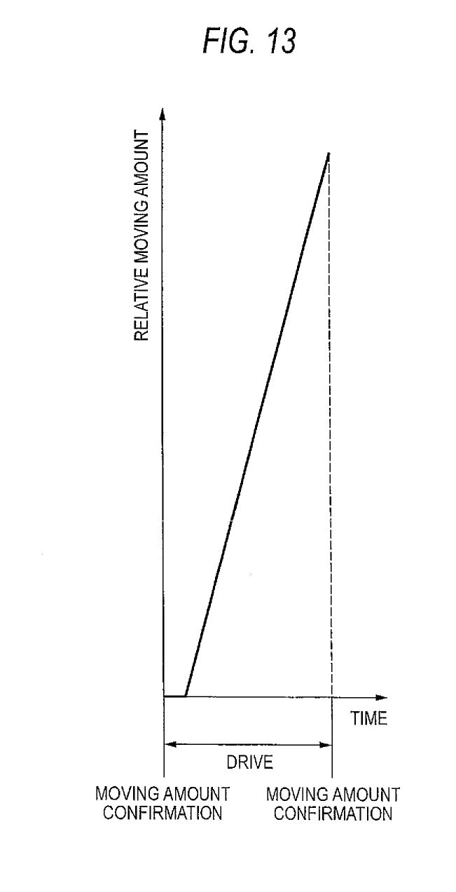

Further, as shown by FIG. 12, the relative movement of the imaging optical system 2 and the imaging device 14 may be changed by a curve shape, or a sinusoidal shape by dividing the period between successive times of confirming the relative moving amount of the imaging optical system 2 and the imaging device 14 by a plurality of periods and making the drive amounts in the divided periods differ from each other. For example, in a case in which it is necessary to input 24 pulses to the first actuator 8 or the second actuator 6 in order to drive by 2 μm in 1 ms period, when 8 pulses are respectively continuously inputted from a first division to a fourth division in periods divided into four, the imaging optical system 2 and the imaging device 14 are driven linearly (broken line of FIG. 13). In contrast thereto, by making the drive amount differ by inputting 12 pulses at the first division, 10 pulses at the second division, 6 pulses at the third division, and 3 pulses at the fourth division, the imaging optical system 2 and the imaging device 14 can be driven sinusoidally, that is, by a curved shape.

A pulse number necessary for driving in this way can be calculated by using a fifth correction equation mentioned later. That is, in a case of intending to drive by 2 μm during a period of 1 ms and when driven in the same direction by 125 ms or longer at a preceding time, pulse numbers necessary by using the fifth correction equation are calculated as −1.31525·2·2+13.84152·2+1.369045+0=24 pulses.

Further, when moved by 2 μm by being divided into four during a period of 1 ms linearly, the movement is carried out by 0.5 μm by 4 times. Therefore, a necessary pulse number becomes −1.31525·0.5·0.5+13.84152·0.5+1.369045+0=8 pulses and driving is carried out by 4 times by 8 pulses.

On the other hand, when moved by 2 μm by being divided into four during a period of 1 ms sinusoidally, a necessary pulse number of a first division becomes −1.31525·(0.874155)²+13.84152·0.874155+1.369045+0=12 pulses. Further, a necessary pulse number of the second division becomes −1.31525·(0.625)²+13.84152·0.625+1.369045+0=10 pulses. Further, a necessary pulse number of the third division becomes −1.31525·(03758446)²+13.84152·0.3758446+1.369045+0=6 pulses. Further, a necessary pulse number of the fourth division can be calculated as −1.31525·(0.125)²+13.84152·0.125+14.369045+0=3 pulses.

Meanwhile, a control of movements of the imaging optical system 2 and the imaging device 14 relative to each other by driving the first actuator 8 or the second actuator 6 is carried out in accordance with an unintentional hand movement state of the imaging apparatus, and when the relative movement speed is changed in accordance with the unintentional hand moving amount, it is preferable to carry out a drive control by using a drive pattern of either of the plurality of the first actuator 8 and the second actuator 6.

For example, during a period between successive times of confirming the relative moving amount of the imaging optical system 2 and the imaging device 14, it is preferable to control to drive the first actuator 8, and the second actuator 6 by combining a first drive pattern of continuously driving the first actuator 8, the second actuator 6, a second drive pattern of bringing the first actuator 8, the second actuator 6 into the nondrive state, the drive state, the nondrive state, and a third drive pattern of repeating not to drive and to drive the first actuator 8, the second actuator 6 by a plurality of times.

As shown by FIG. 13, the first drive pattern is a drive pattern of continuously expand and contract the piezoelectric elements 6a, 8a of the first actuator 8, the second actuator 6 continuously without stopping. The first drive pattern is suitable for high speed movement of the imaging optical system 2 and the imaging device 14. Further, in FIG. 13 or the like, the moving amount is not increased during a predetermined period from starting to drive because the relative moving amount of the imaging optical system 2 and the imaging device 14 is illustrated in consideration that the relative moving amount is small during several pulses after inputting the drive control signal to the first actuator 8, and the second actuator 6.

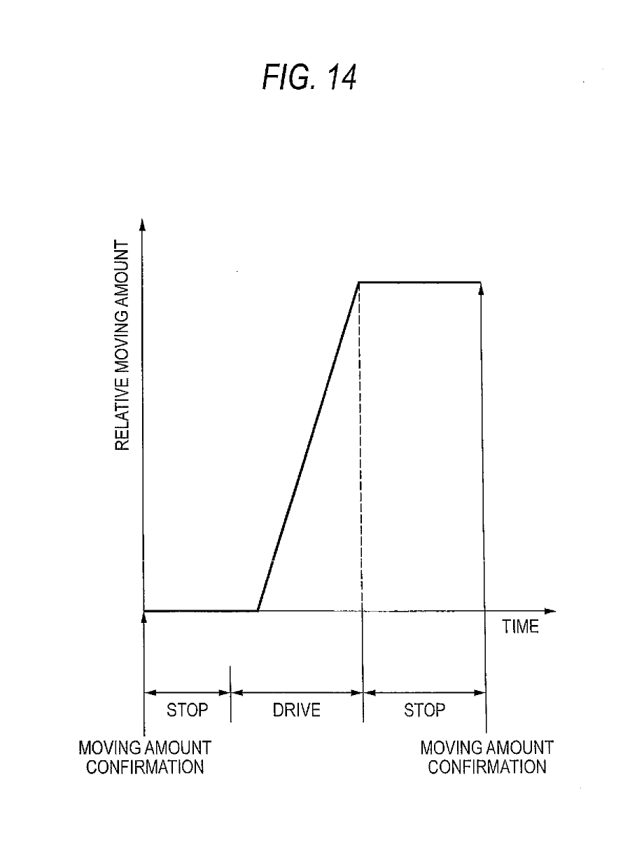

As shown by FIG. 14, the second drive pattern is a drive pattern for driving the first actuator 8, the second actuator 6 by constituting the non-drive state, the drive state, the non-drive state, which is suitable for moving the imaging optical system 2 and the imaging device 14 at a middle speed.

As shown by FIG. 8 or 10, the third drive pattern is a drive pattern of driving by repeating the drive state and the non-drive state of the first actuator 8, the second actuator 6 by a plurality of times, which is suitable for a case in which the imaging optical system 2 and the imaging device 14 are moved at a low speed or the movement speed is changed.

When the first actuator 8 or the second actuator 6 is operated to drive, it is preferable to correct a drive amount per unit time in accordance with a drive characteristic of the first actuator 8 or the second actuator 6. Thereby, accuracy of controlling to move the imaging optical system 2 and the imaging device 14 is promoted.

In correcting the drive amount, the drive characteristic previously detected in designing the imaging apparatus or the like may be integrated to the drive control of the first control portion 30, or the drive characteristic detected in fabricating the imaging apparatus may be integrated to the drive control of the first control portion 30, or the drive characteristic may be detected by driving the first actuator 8 or the second actuator 6 when a power source is inputted to the imaging apparatus and the detected drive characteristic may be integrated to the drive control of the first control portion 30.

When the drive amount is corrected by integrating the drive characteristic detected in fabricating the imaging apparatus to the drive control of the first control portion 30, the first actuator 8 or the second actuator 6 can be operated to drive by absorbing a variation in the drive characteristic for each of the imaging apparatus and further accurate relative movement control of the imaging optical system 2 and the imaging device 14 can be carried out.

When the drive amount is corrected by integrating the drive characteristic detected in inputting the power source of the imaging apparatus to the drive control of the first control portion 30, the first actuator 8 or the second actuator 6 can be operated to drive by absorbing a variation in the drive characteristic in an environment of using the imaging apparatus of a temperature characteristic of an electric part of a Hall element or the like, and the relative movement control of the imaging optical system 2 and the imaging device 14 can be carried out further accurately.

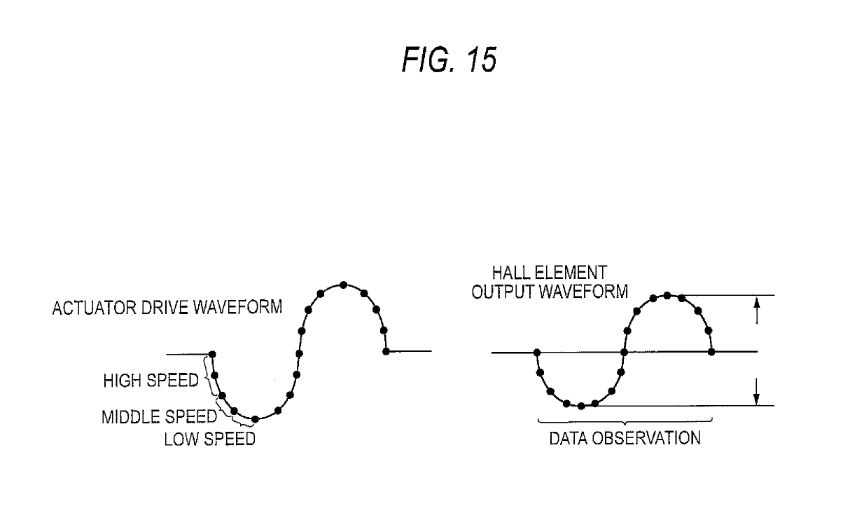

In this case, as shown by FIG. 15, the imaging optical system 2 is reciprocally moved by rotating regularly and rotating reversely the first actuator 8 or the second actuator 6 in inputting the power source of the imaging apparatus. The movement state at this occasion is detected by the Hall element 15, and the drive characteristic of the first actuator 8 or the second actuator 6 is detected based on a result of the detection.

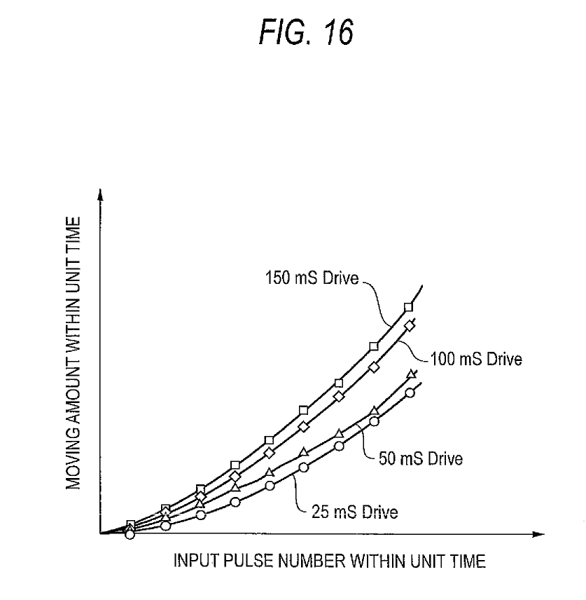

It is preferable to correct the drive amount of the first actuator 8 or the second actuator 6 such that the longer the continuous drive period of the first actuator 8 or the second actuator 6 in the same direction, the smaller the number of inputting the drive pulses per unit time. As the drive characteristic of the first actuator 8 or the second actuator 6, as shown by FIG. 16, there is a tendency that the longer the continuous drive period in the same direction, the larger the relative moving amount of the imaging optical system 2 and the imaging device 14. Therefore, by correcting the drive amount such that the longer the continuous drive period of the first actuator 8 or the second actuator 6 in the same direction, the smaller the number of inputting the drive pulse per unit time, the accurate movement control can be carried out.

Further, when the direction of driving the first actuator 8 or the second actuator 6 is reversed, it is preferable to increase the drive pulse number per unit time by adding an amount of adding pulses of reversion.

Correction of the drive amount may be carried out by, for example, setting a plurality of correction equations or correction tables per the drive period in the same direction to the first control portion 30 and calculating the drive pulse number per unit time by using the correction equation or the correction table which differs for each drive period. Further, correction of the reverse drive may be carried out by, for example, setting a correction equation or a correction table in the case of reverse drive to the first control portion 30 and calculating the drive pulse number per unit time by using a different correction equation or the correction table when the reverse drive is carried out.

As described above, by controlling to drive the first actuator 8 and the second actuator 6 based on the detecting signal S1 of the gyro sensor 50 and the detecting signal S2 of the Hall element 15, the first actuator 8 and the second actuator 6 are operated such that the expanding speed and the contracting speed of the piezoelectric element 8a or 6a differ from ach other and the drive shaft 8b or 6b is reciprocally moved repeatedly. The first moving member 11 is moved in the first direction X relative to the imaging device 14 by driving the first actuator 8, the imaging optical system 2 is moved in the second direction Y along with the second moving member 5 relative to the first moving member 11 by driving the second actuator 6, and the imaging device 14 and the imaging optical system 2 are moved relative to each other.

Thereby, even when the unintentional hand movement is produced in the imaging apparatus, the imaging device 14 and the imaging optical system 2 are controlled to move relative to each other and the unintentional hand movement is restrained for the image taken by the imaging device 14.

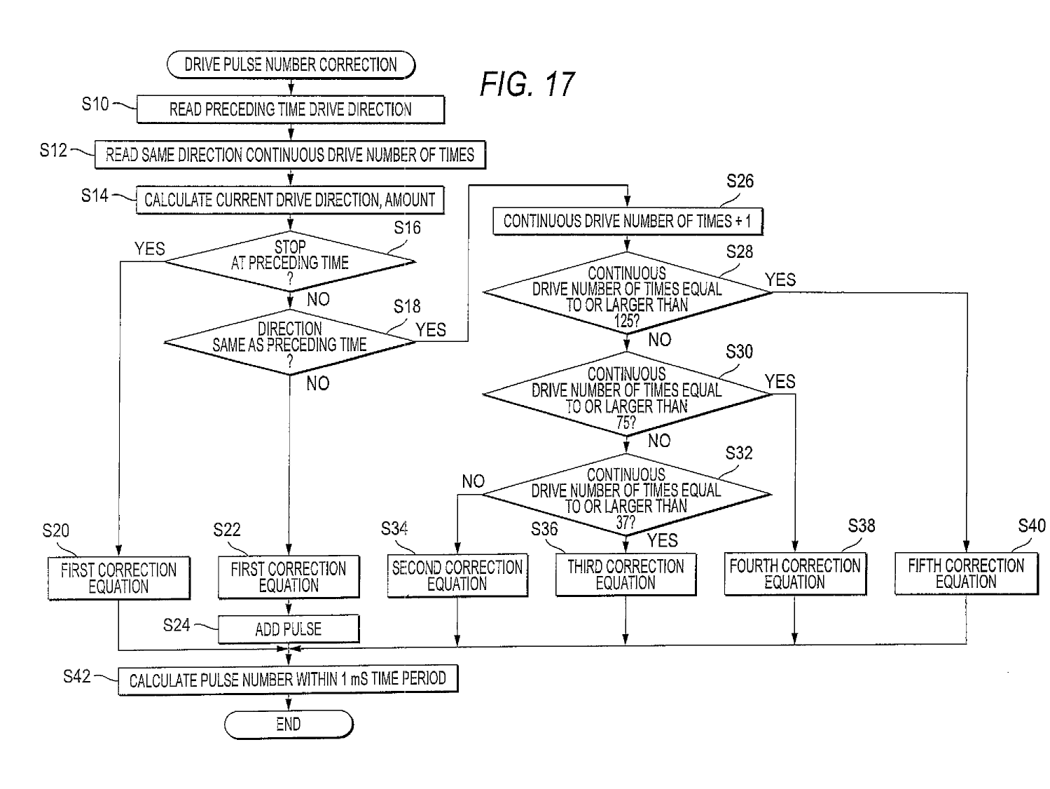

FIG. 17 is a flowchart of a drive amount pulse number correction processing of the first actuator 8 or the second actuator 6. The drive amount pulse number correction processing is executed repeatedly by the first control portion 30 and is carried out for calculating a pulse number within a period of, for example, 1 ms.

As shown by S10 of FIG. 17, a preceding time drive direction is read. The preceding time drive direction is read by reading a direction flag stored with, for example, 1 in the case of the regular drive direction, 2 in the case of the reverse drive direction, and 0 in the case of the stop state.

Further, the operation proceeds to S12, and the same direction continuous drive number of times is read. For example, when a state of the regular drive direction is continued by 40 times, 40 is lead as the same direction continuous drive number of times. Further, the operation proceeds to S14, and the current drive direction and the drive amount are processed to calculate. The processing of calculating the current drive direction and the drive amount is a processing of calculating the current drive direction and the drive amount constituting a basis thereof and is calculated based on the detecting signals S1x and S1y of the gyro sensor 50 and the detecting signals S2x and S2y of the Hall element 15.

Further, the operation proceeds to S16, and it is determined whether the preceding time drive direction is brought into a stop state. When it is determined that the preceding time drive direction is brought into the stop state at S16, a first correction equation is selected as a correction equation of the drive pulse number (S20). As the first correction equation, a correction equation constituting a quadratic equation of the drive amount is used as shown by Equation (1) as follows.

Y=a·X²+b·X+c (1)

In Equation (1), notation Y designates a pulse number within a period of 1 ms, notation X designates the drive amount (μm), notations a, b and c designate constants. In the first correction equation, for example, a is −3.02318, b is 24.64697, c is 4.972353.

When it is determined that the preceding drive direction is not brought into the stop state at S16, it is determined whether the current drive direction is a direction the same as that of the preceding time (S18). When it is determined that the current drive direction is not the direction the same as that of the preceding time at S18, the first correction equation is selected as the correction equation of the drive pulse number (S22), and pulses are added to the first correction equation (S24). A pulse adding processing is a processing of increasing the pulse number more than normal for applying power of movement when the drive direction is reversed. As a number of adding pulses, a number previously set to the first control portion 30 is used. For example, in a case of starting to drive from the preceding time stop state and a case of driving 2 μm by 1 ms, when the pulse number is calculated by the first correction equation, −3.02318×2×2+24.64697×2+4.972353=42 pulses. In contrast thereto, in a case of driving by reversing the drive direction and a case of driving 2 μm by 1 ms, the pulse number calculated by the first correction equation is added with pulses in reverse rotation (10 pulses) to be −3.02318×2×2+24.64697×2+4.972353+10=52 pulses.

Meanwhile, when it is determined that the current drive direction is a direction the same as that of the preceding time, the continuous drive number of times in the same direction is added with 1 (S26), and it is determined whether the continuous drive number of times is equal to or larger than 125 times (S28). When it is determined that continuous drive number of times is not equal to or larger than 125 times at S28, it is determined whether the continuous drive number of times is equal to or larger than 75 times (S30).

When it is determined that the continuous drive number of times is not equal to or larger than 75 times at S30, it is determined whether the continuous drive number of times is equal to or larger than 37 times (S32). When it is determined that the continuous drive number of times is not equal to or larger than 37 times at S32, a second correction equation is selected as the correction equation of the drive pulse number (S37). The correction equation uses the correction equation of Equation (1) for calculating the drive pulse number to be smaller than that of the first correction equation. In the second correction equation, for example, a is −2.1228, b is 19.98213, c is 3.730666.

When it is determined that the continuous drive number of times is equal to or larger than 37 times at S32, a third correction equation is selected as the correction equation of the drive pulse number (S36). The third correction equation uses the correction equation (1) for calculating the drive pulse number to be smaller than that of the second correction equation. In the third correction equation, for example, a is −1.78803, b is 17.04244, c is 2.501763.

When it is determined that the continuous drive number of times is equal to or larger than 75 times at S30, a fourth correction equation is selected as the correction equation of the drive pulse number (S38). The fourth correction equation uses the correction equation (1) for calculating the drive pulse number to be smaller than that of the first correction equation. In the fourth correction equation, for example, a is −1.40279, b is 14.76191, c is 1.845051.

When it is determined that the continuous drive number of times is equal to or larger than 125 times at S28, a fifth correction equation is selected as the correction equation of the drive pulse number (S40). The fifth correction equation uses the correction equation (1) for calculating the drive pulse number to be smaller than that of the first correction equation. In the fifth correction equation, for example, a is −1.31525, b is 13.38152, c is 1.369045.

Further, the operation proceeds to S42 and the pulse number calculating processing within the period of 1 ms is carried out. The pulse number calculating processing is a processing of calculating the pulse number by using the correction equation selected by S20, 22, 34, 36, 38 and 40 and adding pulses (S24) as necessary. When the pulse number calculating processing of S42 is finished, a series of control processings are finished.

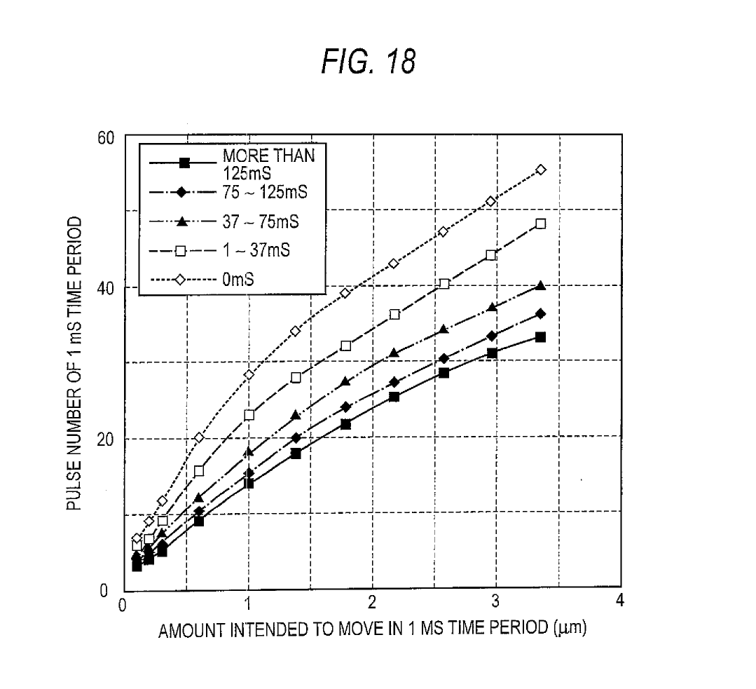

As described above, according to the drive amount pulse number correction processing, as shown by FIG. 18, the larger the continuous drive number of times in the same direction, the smaller the pulse number per unit time can be made and the smaller the continuous drive number of time in the same direction, the larger the pulse number per unit time can be made. Thereby, the moving amount per unit time can further be made to be proximate to be constant and the movement control can accurately be carried out.

Further, according to the drive amount pulse number correction processing, when the drive direction is reversed, the drive pulse number is set to be larger than that in the case of not reversing the drive direction. Therefore, by driving the first actuator 8 or the second actuator 6 by applying drive pulses larger than that when slowly start to move by reversing the drive direction, the moving amount per unit time can further be made to be proximate to be constant and the movement control can accurately be carried out.

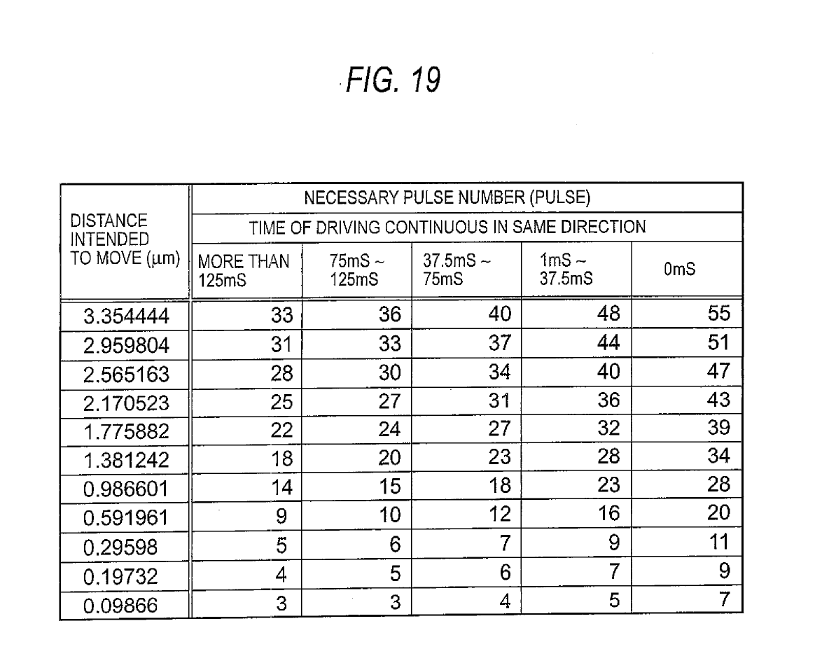

Further, although in the above-descried drive amount pulse number correction processing, an explanation has been given of a case of calculating the pulse number per unit time relative to the drive amount by the correction equation, the pulse number per unit time may be calculated by using a table. For example, as shown by FIG. 19, a table may previously be set in accordance with a distance of intending to move, that is, the continuous drive period in the direction the same as that of the drive amount per unit time, and a pulse number necessary for driving may be set in accordance with the drive amount and the continuous drive period.

Further, the above-described drive amount pulse number correction processing may be applied not only to a case of carrying out the drive control by repeating to drive and stop the first actuator 8 or the second actuator 6 during a period between successive times of confirming the relative moving amount of the imaging optical system 2 and the imaging device 14 but also to a case of carrying out the drive control without repeating to drive and stop the first actuator 8 or the second actuator 6 during the period between the time of confirming and the time of successively confirming the relative moving amount of the imaging optical system 2 and the imaging device 14.

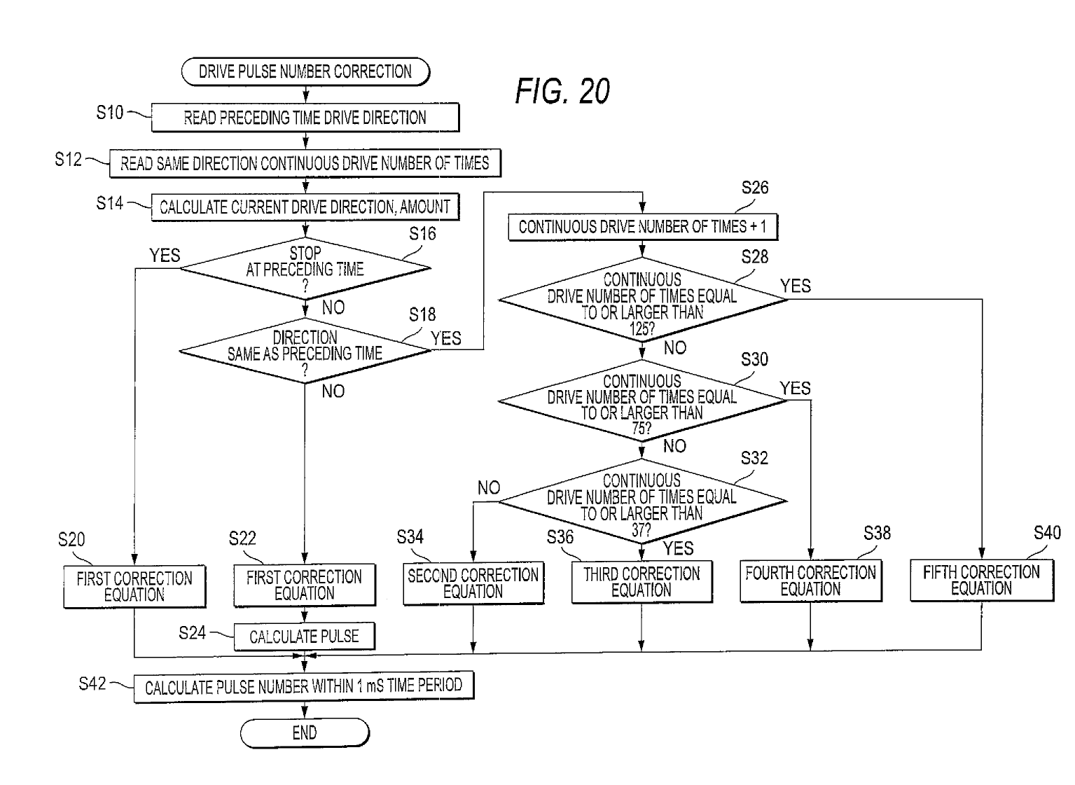

Further, in the above-described drive amount pulse number correction processing, it is preferable to set the pulse number added in the pulse adding processing of S24 of FIG. 17 based on the drive pulse number per unit time or the relative moving amount of the imaging optical system 2 and the imaging device 14 immediately before reversion. For example, the pulse adding processing of S24 of FIG. 17 is made to constitute a first calculating processing (refer to FIG. 20). In this case, as the pulse calculating processing, a pulse adding number in reversion is calculated based on the drive pulse number or the moving amount immediately before reversion and the calculated pulse adding number is added to the drive pulse number.

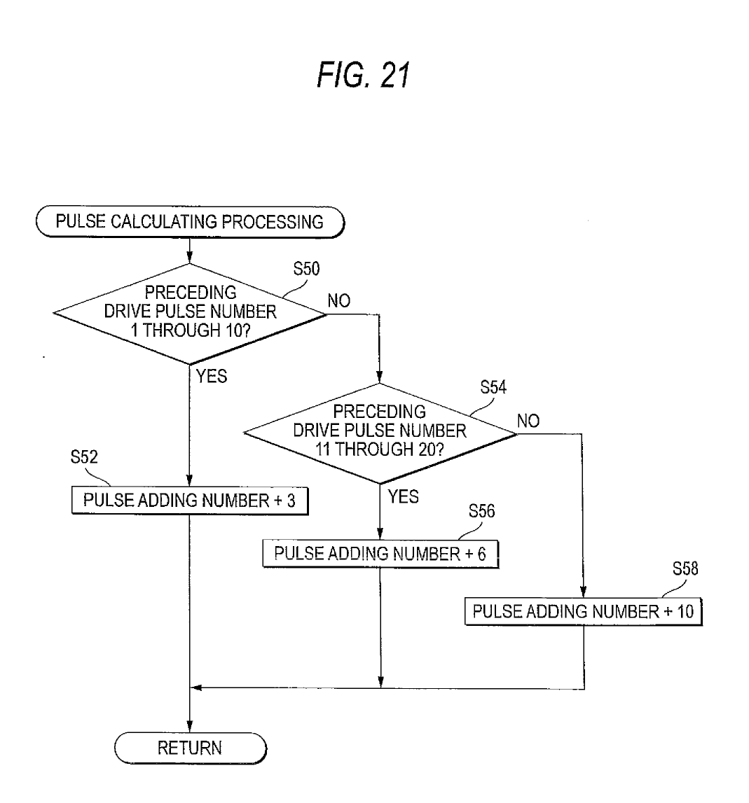

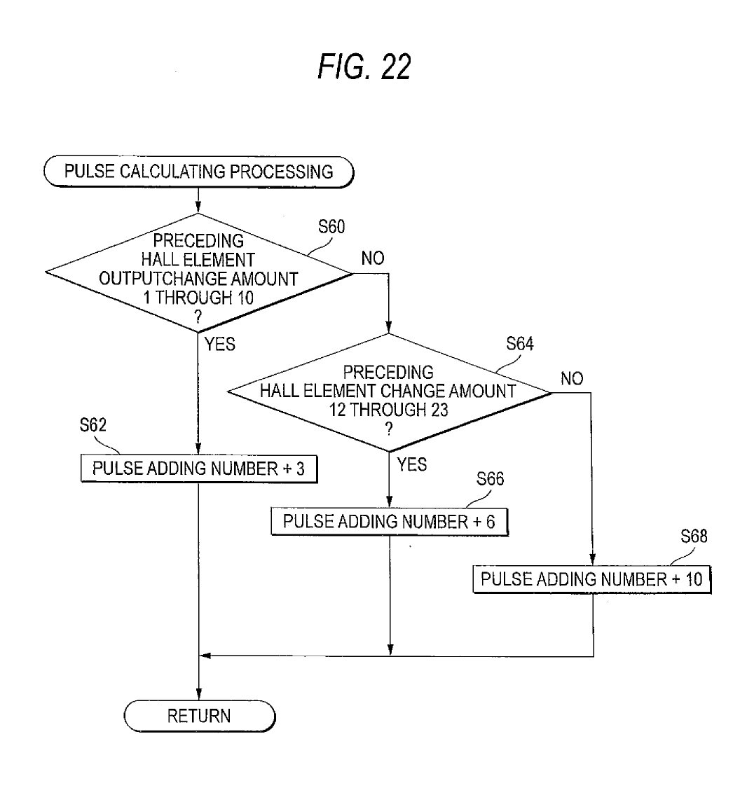

FIGS. 21 and 22 are flowcharts showing a processing content of the pulse calculating processing.

The pulse calculating processing of FIG. 21 is a processing of calculating the pulse adding number in accordance with the drive pulse number per unit time immediately before reversion (per 1 ms of preceding time).

First, at S50 of FIG. 21, it is determined whether the drive pulse number per unit time preceding time is 1 through 10. The determination is a processing of determining whether the drive pulse number per 1 ms at preceding time immediately before reversion is 1 through 10. When it is determined that the drive pulse number per unit time at preceding time is 1 through 10 at S50, the pulse adding number is calculated as 3 pulses (S52).

On the other hand, when it is determined that the drive pulse number per unit time at the preceding time is not 1 through 10 at S50, it is determined whether the drive pulse number per unit time at preceding time is 11 through 20 (S54). When it is determined that the drive pulse number per unit time at the preceding time is 11 through 20 at S54, the pulse adding number is calculated as 6 pulses (S56). On the other hand, when the drive pulse number per unit at the preceding time is not 11 through 20 at S54, it is determined that the pulse number is equal to or larger than 21 and the pulse adding number is calculated as 10 pulses (S58). Further, a series of control processings of the pulse calculating processing are finished.

According to the pulse calculating processing, the larger the drive pulse number per unit time immediately before reversion, the larger the pulse adding number in reversion is calculated. Therefore, the relative moving amount of the imaging optical system 2 and the imaging device 14 can be made to be in line with the expected value and the pertinent unintentional hand movement correction can be carried out.

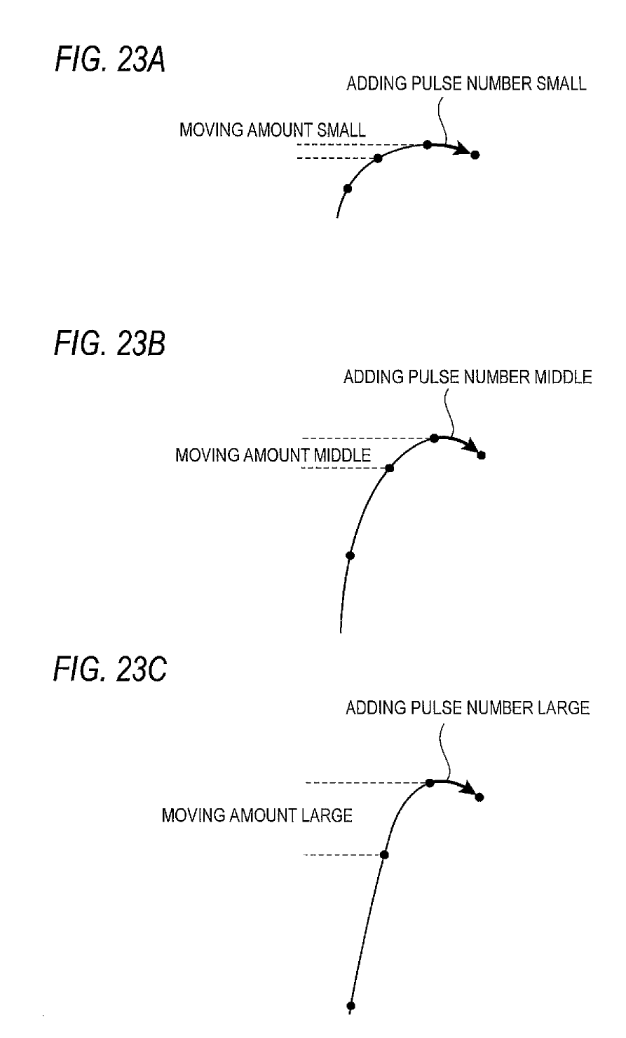

For example, when the moving amount for reversion is small as shown by FIGS. 23 (A) through (C), the adding pulse number is made to be small (for example, 3 pulses), when the moving amount before reversion is about middle, the adding pulse number is made to be about middle (for example, 6 pulses), and when the moving amount before reversion is large, the adding pulse number is made to be large (for example, 10 pulses).

Thereby, the moving amount after reversion is made to be in line with the expected value (refer to arrow marks of bold lines in FIGS. 23(A) through (C)). Therefore, the pertinent unintentional hand movement correction can be carried out.

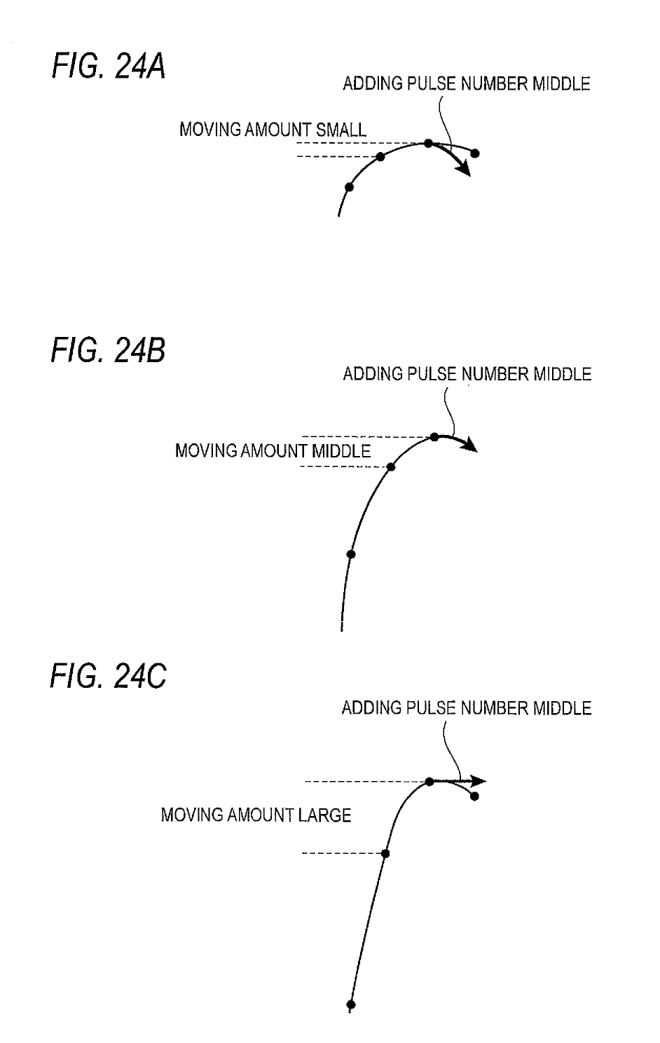

In contrast thereto, when the adding pulse number in reversion is made to be constant regardless of the moving amount before reversion (for example, 6 pulses), as shown by FIG. 24, although when the moving amount before reversion is about middle, the moving amount after reversion is in line with the expected value (refer to FIG. 24(B)), when the moving amount before reversion is small, the moving amount after reversion is excessively large not to be in line with the expected value (refer to FIG. 24(A)), and when the moving amount before reversion is large, the moving amount after reversion is excessively small not to be in line with the expected value (refer to FIG. 24(C)). Therefore, the pertinent unintentional hand movement collection is not carried out.

A pulse calculating processing of FIG. 22 is a processing of calculating a pulse adding number in accordance with the relative moving amount of the imaging optical system 2 and the imaging device 14 per unit time immediately before reversion (per 1 ms of the preceding time).

First, at S60 of FIG. 22, it is determined whether a Hall element output change amount per unit time of the preceding time is 1 through 11. The determination is a processing of determining whether an amount of changing the output of the Hall element 15 per 1 ms at the preceding time immediately before reversion is 1 through 11. The amount of changing the output of the Hall element 15 is shown by an A/D value of 10 bits. When it is determined that the Hall element output change amount per unit time at the preceding time is 1 through 11 at S60, the pulse adding number is calculated as 3 pulses (S62).

On the other hand, when it is determined that the Hall element output change amount per unit time at the preceding time is not 1 through 11, it is determined whether the Hall element output change amount per unit time at the preceding time is 12 through 23 (S60). When it is determined that the Hall element output change amount per unit time at the preceding time is 12 through 23 at S64, the pulse adding number is calculated as 6 pulses (S66). On the other hand, when the Hall element output change amount per unit time at the preceding time is not 12 through 23 at S64, it is determined that the Hall element output change amount is equal to or larger than 24, and the pulse adding number is calculated as 10 pulses (S68). Further, a series of control processings of the pulse calculating processing are finished.

According to the pulse calculating processing, the larger the Hall element output change amount per unit time immediately before reversion, the larger the pulse adding number at reversion is calculated. Therefore, similar to the above-described pulse calculating processing, the relative moving amount of the imaging optical system 2 and the imaging device 14 can be in line with the expected value and pertinent unintentional hand movement correction can be carried out.

As described above, according to the imaging apparatus according to the embodiment, by carrying out the drive control by repeating to drive and stop the first actuator 8 or the second actuator 6 during a period between successive times of confirming the relative moving amount of the imaging optical system 2 and the imaging device 14, during the period from confirming to successively confirming the relative moving amount of the imaging optical system 2 and the imaging device 10, the relative moving position of the imaging optical system 2 and the imaging device 14 can finely be controlled. Therefore, the relative positional relationship of the imaging optical system 2 and the imaging device 14 can be made to be proximate to a desired positional relationship and the highly accurate movement control can be carried out.

Further, in the imaging apparatus according to the embodiment, by correcting the drive amount per unit time in accordance with the characteristic of driving the first actuator 8 or the second actuator 6, the accuracy of the movement control of the imaging optical system and the imaging device can be promoted.

Further, in the imaging apparatus according to the embodiment, by detecting the drive characteristic by driving the first actuator 8 or the second actuator 6 in inputting a power source and correcting the drive mount per unit time in accordance with a detected drive characteristic, the drive section can be operated to drive by absorbing a variation in the drive characteristic in an environment of using the imaging apparatus of a temperature characteristic of an electric part of the Hall element or the like included in the imaging apparatus and the like. Therefore, further accurate relative movement control of the imaging optical system and the imaging device can be carried out.

Further, by controlling to drive the first actuator 8 or the second actuator 6 by making the period of driving or the period of stopping the first actuator 8 or the second actuator 6 which is repeated during the period between the time of confirming and the time of successively confirming the relative moving amount of the imaging optical system 2 and the imaging device 14 differ from each other, the relative movement speed of the imaging optical system 2 and the imaging device 14 can be changed. Therefore, when the first actuator 8 or the second actuator 6 is used for driving the unintentional hand movement correction, a case of changing the speed of the unintentional hand movement sinusoidally or the like can be dealt with and the pertinent unintentional hand movement correction can be carried out.

At this occasion, by constituting a change over time of the relative moving amount of the imaging optical system 2 and the imaging device 14 sinusoidal, the unintentional hand movement correction in accordance with the unintentional hand movement vibration is constituted, and therefore, the pertinent unintentional hand movement correction can be carried out.

Further, according to the imaging apparatus according to the embodiment, the longer the continuous drive in the same direction in the relative movement of the imaging optical system 2 and the imaging device 14, the smaller the drive pulse number per unit time inputted to the first actuator 8 or the second actuator 6. Therefore, the relative moving amount of the imaging optical system 2 and the image element 14 per unit time can be made to be proximate to a target value (expected value) and the movement control can accurately be carried out.

Further, according to the imaging apparatus according to the embodiment, when the moving direction is reversed in the relative movement of the image optical system 2 and the imaging device 14, in comparison with a case of not reversing the moving direction, the drive pulse number per unit time inputted to the first actuator 8 or the second actuator 6 is increased. Therefore, the first actuator 8 or the second actuator 6 can be driven by applying a number of drive pulses when started to move slowly by reversing the moving direction, and the moving amount per unit time can further be made to be proximate to the target value (expected value). Therefore, the movement control can accurately be carried out.

Further, according to the imaging apparatus according to the embodiment, when the movement direction is reversed in the relative movement of the imaging optical system 2 and the imaging device 14, by setting the number of adding the drive pulse number after reversion in accordance with the relative moving amount immediately before reversion, the relative movement amount of the imaging optical system 2 and the imaging device 14 can be made to be proximate to the target value (expected value). Therefore, the pertinent unintentional hand movement correction is carried out.

Further, the above-described embodiment shows an example of the imaging apparatus according to the invention. The imaging apparatus according to the invention is not limited to the imaging apparatus according to the embodiment but the imaging apparatus according to the embodiment may be modified or may be applied to other apparatus within the range of not changing the gist described in respective claims.

For example, although according to the embodiment, an explanation has been given of the unintentional hand movement correction mechanism for moving the imaging optical system 2 relative to the imaging device 14 in accordance with the unintentional hand movement, the imaging device 14 may be moved relative to the image topical system 2. Also in this case, operation and effect similar to those of the imaging apparatus according to the above-descried embodiment can be achieved.

Further, although according to the embodiment, the actuator of the imaging apparatus using the piezoelectric element is adopted, an actuator using other drive part of a motor or the like may be adopted. Further, although according to the embodiment, an explanation has been given of a case of moving the imaging optical system 2 and the imaging device 14 relative to each other in the direction orthogonal to the optical axis direction to be applied to the unintentional hand movement correction mechanism, the imaging optical system 2 and the imaging device 14 may be moved relative to each other in the optical axis direction to be applied to a variable power adjusting mechanism of the imaging optical system 2.

This application claims foreign priority from Japanese Patent Application No. 2007-89634 filed Mar. 29, 2007, the contents of which is herein incorporated by reference.

What is claimed is:

1. An imaging apparatus comprising:
an imaging optical system;
an imaging device;
a drive section that relatively moves the imaging optical system and the imaging device; and
a control section that controls the drive section so as to repeatedly drive and stop the drive section during a period between successive times of confirming a relative moving amount of the imaging optical system and the imaging device.

2. The imaging apparatus according to claim 1, wherein the control section controls the drive section so as to bring the drive section in a stopped state, a driving state and a stopped state during the period.

3. The imaging apparatus according to claim 1, wherein the control section controls the drive section by a combination of: a first drive pattern of continuously driving the drive section during the period; a second drive pattern of bringing the drive section in a stopped state, a driving state and a stopped state during the period; and a third drive pattern of repeating stopping and driving the driving section multiple times during the period.

4. The imaging apparatus according to claim 1, wherein the control section corrects a drive amount per unit time in accordance with a drive characteristic of the drive section.

5. The imaging apparatus according to claim 4, wherein when a power is turned on, the control section makes the drive section operate to detect the drive characteristic of the drive section, and the control section corrects the drive amount per unit time in accordance with the detected drive characteristic.

6. The imaging apparatus according to claim 1, wherein the control section controls the drive section so that times of repeatedly driving or stopping the driving section during the period are different.

7. The imaging apparatus according to claim 1, wherein the control section controls the drive section so that the relative moving amount of the imaging optical system and the imaging device sinusoidally changes in time.

8. An imaging apparatus comprising:
an imaging optical system;
an imaging device;
a drive section that relatively moves the imaging optical system and the imaging device; and
a control section that controls the drive section so as to input a drive pulse to the drive section so that the number of drive pulses per unit time becomes smaller as a time of operating the drive section in a same direction is longer.

9. An imaging apparatus comprising:
an imaging optical system;
an imaging device;
a drive section that relatively moves the imaging optical system and the imaging device; and
a control section that controls the drive section input a drive pulse to the drive section so that the number of drive pulses per unit time in a case of reversing a moving direction in relatively moving of the imaging optical system and the imaging device in comparison with a case in which the moving direction is not reversed.

10. The imaging apparatus according to claim 9, wherein the control section sets an amount of increasing the number of drive pulses per unit time after reversion based on the number of drive pulses per unit time immediately before the reversing.

11. The imaging apparatus according to claim 10, wherein the control section increases the amount of increasing the number of drive pulses per unit time after the reversing so that the number of drive pulses per unit time after the reversing is increased more as the number of drive pulses per unit time immediately before the reversing is larger.

12. The imaging apparatus according to claim 9, wherein the control section sets an amount of increasing the number of drive pulses per unit after reversion based on a relative moving amount of the imaging optical system and the imaging device per unit time immediately before the reversing.

13. The imaging apparatus according to claim 12, wherein the control section increases the amount of increasing the number of drive pulses per unit time after the reversing so that the amount of increasing the number of drive pulses per unit time after the reversing is larger as the relative moving amount of the imaging optical system and the imaging device per unit time immediately before the reversing is larger.

14. The imaging apparatus according to claim 1, wherein the drive section includes an actuator, the actuator including a piezoelectric element and a drive shaft reciprocally moving in accordance with an operation of expanding or contracting the piezoelectric element, wherein the imaging optical system and the imaging device is relatively moved in accordance with moving a member frictionally engaged with the drive shaft.

15. The imaging apparatus according to claim 8, wherein the drive section includes an actuator, the actuator including a piezoelectric element and a drive shaft reciprocally moving in accordance with an operation of expanding or contracting the piezoelectric element, wherein the imaging optical system and the imaging device is relatively moved in accordance with moving a member frictionally engaged with the drive shaft.

16. The imaging apparatus according to claim 9, wherein the drive section includes an actuator, the actuator including a piezoelectric element and a drive shaft reciprocally moving in accordance with an operation of expanding or contracting the piezoelectric element, wherein the imaging optical system and the imaging device is relatively moved in accordance with moving a member frictionally engaged with the drive shaft.
